(19) United States
(12) Patent Application Publication
(10) Pub. No.: US 2023/0196448 A1
(43) Pub. Date: Jun. 22, 2023

(54) DISPLAY SYSTEM, SERVER DEVICE, AND DISPLAY DEVICE

(71) Applicant: TOSHIBA TEC KABUSHIKI KAISHA, Tokyo (JP)

(72) Inventor: Yoshiaki OKAWA, Sunto Shizuoka (JP)

(21) Appl. No.: 17/960,720

(22) Filed: Oct. 5, 2022

(30) Foreign Application Priority Data
Dec. 17, 2021 (JP) 2021-205560

(51) Int. Cl. G06Q 30/06

(52) U.S. Cl. CPC G06Q 30/0641; G06Q 30/0623

(57) ABSTRACT

A display system for retail stores includes a display device near a displayed product to display information regarding the product on a display screen. A server device communicates with the display device and includes a processor that acquires, from a customer's mobile terminal device, a terminal identification and product identification information regarding products registered for purchase using the mobile terminal device. The processor selects a display pattern based on the acquired product identification information, and then output a pattern identification of the selected display pattern type to the mobile terminal device. The display device has detection unit to detect the pattern identification output by the mobile terminal device and a display control unit to display the information regarding the displayed product on the display screen in a display pattern matching the display pattern type indicated by the pattern identification output from the mobile terminal device when the customer approaches.

### CROSS-REFERENCE TO RELATED APPLICATION

This application is based upon and claims the benefit of priority from Japanese Patent Application No. 2021-205560, filed Dec. 17, 2021, the entire contents of which are incorporated herein by reference.

### FIELD

Embodiments described herein relate to a display system, a server device, and a display device.

### BACKGROUND

In the related art, a store system that displays information to a customer regarding a product that the stores sells is known. As a display device that displays the information about a product in such a system, a display device called an electronic shelf label or an electronic point of purchase advertising (POP) provided in direct correspondence with the relevant product is particularly known.

Such a display device electronically displays information regarding the relevant product, such as a name, a price, and a production district (place of origin), and has an advantage that a display content can be easily changed when the displayed product associated with the device is changed.

However, the information in which a customer who visits the store is interested may be different for each customer. For example, it is considered that a certain customer is more interested in the price of the product, but another customer may be interested in the production district of the product. However, the display device in the related art has a single display pattern of the information regarding the displayed product, and cannot dynamically execute a display information according to the particular interests of each customer. Therefore, there is room for improvement in the display devices in the related art in executing information displays to attain a more appealing effect for a customer.

### BRIEF DESCRIPTION OF THE DRAWINGS

FIG. 1 is a diagram illustrating an outline of a store system including a display system according to a first embodiment.

FIG. 2 is a block diagram illustrating a hardware configuration of a server device.

FIG. 3 is a diagram illustrating a data configuration of a registration information unit.

FIG. 4 is a diagram illustrating a data configuration of a product master stored in a memory unit.

FIG. 5 is a diagram illustrating a data configuration of a purchase information management file.

FIG. 6 is a diagram illustrating a data configuration of a display pattern file.

FIG. 7 is a diagram illustrating a data configuration of a terminal management file.

FIG. 8 is a diagram illustrating a display example of display items in a standard pattern executed by a display device.

FIG. 9 is a block diagram illustrating functional aspects of a control unit of a server device.

FIG. 10 is a block diagram illustrating a hardware configuration of a display device.

FIG. 11 is a diagram illustrating a data configuration of a display pattern management file stored in a memory unit.

FIG. 12 is a block diagram illustrating functional aspects of a control unit of a display device.

FIG. 13 is a block diagram illustrating a hardware configuration of a terminal device.

FIG. 14 is a block diagram illustrating functional aspects of a control unit of a terminal device.

FIG. 15 is a sequence chart illustrating an operation of a store system.

FIG. 16 is a flowchart illustrating a display pattern selection by a control unit of a display device.

FIG. 17 is a flowchart illustrating a display information display by a control unit of a display device.

FIG. 18 is a sequence chart illustrating an operation of a store system according to a second embodiment.

FIG. 19 is a flowchart illustrating a display information display executed by a control unit of a display device.

FIG. 20 is a block diagram illustrating a hardware configuration of a server device according to a third embodiment.

FIG. 21 is a diagram illustrating a data configuration of a position information unit.

FIG. 22 is a diagram illustrating a data configuration of a display data information unit.

FIG. 23 is a diagram illustrating a data configuration of a display data management file stored in a memory unit.

FIG. 24 is a diagram illustrating a data configuration of a beacon management file.

FIG. 25 is a block diagram illustrating functional aspects of a control unit.

FIG. 26 is a flowchart illustrating a display data output.

### DETAILED DESCRIPTION

In general, according to one embodiment, a display system, a server device, and a display device that are capable of executing in store advertisement (or other informational) display to attain a more appealing effect for a customer are provided.

According to one embodiment, a display system includes a display device at a location proximate to a displayed product. The display device is configured to display information regarding the displayed product on a display screen. A server device communicates with the display device. The server device includes a processor configured to acquire, from a mobile terminal device of a customer, a terminal identification for the mobile terminal device and product identification information regarding products registered for purchase by the customer using the mobile terminal device. The processor then selects a display pattern type from a plurality of display pattern types based on the acquired product identification information, and then output a pattern identification identifying the selected display pattern type to the mobile terminal device. The display device has a detection unit configured to detect the pattern identification being output by the mobile terminal device when the mobile terminal device is within a predetermined range of the display device. The display device also has a display control unit configured to display the information regarding the displayed product on the display screen in a display pattern corresponding to the display pattern type indicated by the pattern identification detected by the detection unit.

Hereinafter, a display system, a server device, and a display device according to certain example embodiments will be described with reference to the drawings. The disclosure is not limited to these particular example embodiments. In an example, a terminal device moving with a customer within a store is a tablet terminal provided on a shopping cart. In other examples, the terminal device may be a smartphone or the like owned and carried by the customer.

### First Embodiment

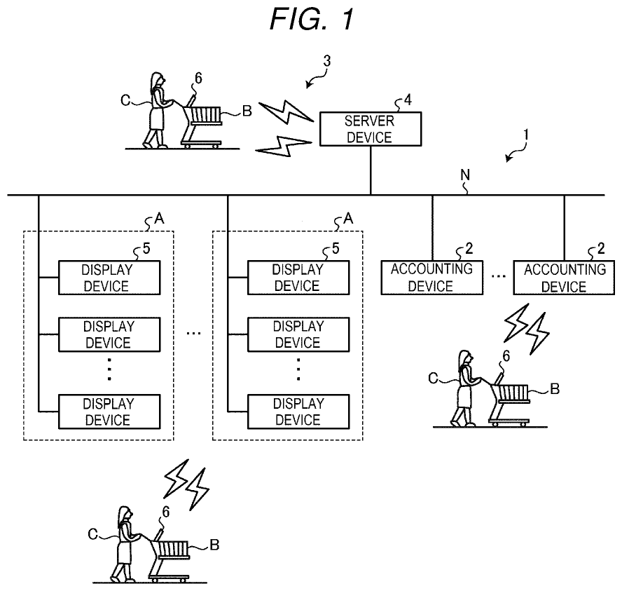

A display system, a server device, and a display device according to a first embodiment will be described with reference to the drawings. FIG. 1 is a diagram illustrating an outline of a store system including a display system. A store system 1 according to the first embodiment is applied to, for example, a store such as a supermarket that sells products. The store system 1 includes a plurality of accounting devices 2 and a display system 3.

The display system 3 includes a server device 4, a plurality of display devices 5 provided on product display shelves A, and terminal devices 6 provided on shopping carts B. The accounting devices 2, the server device 4, and the display devices 5 communicate with one another via a network N such as a local area network (LAN). The terminal devices 6 can be communicably connected to the accounting devices 2 and the server device 4 via a wireless LAN or the like. In addition, the terminal devices 6 can communicate with the display devices 5 by short-range wireless communication such as Bluetooth®.

The accounting device 2 is, for example, a self-service accounting device at which a customer C executes accounting (transaction settlement) by himself or herself. The accounting device 2 executes accounting related to payment methods such as cash settlement or cashless settlement (such as credit card settlement) based on accounting information for a transaction including product information registered by the terminal device 6. In this context, “accounting” is processing associated with paying the price of a product being purchased by the customer C. The accounting device 2 may be a point of sales (POS) terminal operated by a store staff (store clerk) in some examples.

The server device 4 functions as a store server that manages store information. The server device 4 receives, from the accounting device 2, the product information regarding the products paid for in the accounting and settlement information related to a settlement method and the like used in the accounting. In addition, the server device 4 receives, from the accounting device 2, sales information indicating a cumulative sales amount over a predetermined period (for example, one day). The server device 4 individually manages the product information, the settlement information, and the sales information that are received from the accounting device 2, and executes overall sales management functions for one store. In addition, for products sold in the store, the server device 4 stores a product master in which a product code is associated with the product information (a product name, a price, and the like), and sends the product master (or information therefrom) to the terminal device 6 as appropriate.

The server device 4 stores also display patterns for product display information (hereinafter, also simply referred to as “display information”) to be shown on the display devices 5. The server device 4 acquires, from the terminal device 6, the product code(s) for identifying a product(s) to be purchased by the customer C, and selects a display pattern based on the product code(s). For example, when a large number of the acquired product codes relate to bargains, the server device 4 estimates that the customer C is highly interested in prices and selects the display pattern that emphasizes the price. The server device 4 then outputs pattern identification information indicating the selected display pattern to the terminal device 6 that sent the product code. The product code is an example of product identification information.

The display devices 5 are provided on the product display shelves A in one-to-one correspondence with the product types thereon. In the example illustrated in FIG. 1, since a plurality of products are displayed on each of the product display shelves A, a plurality of display devices 5 are provided on each of the product display shelves A. The display device 5 displays the display information related to a corresponding product. Items of the display information include, for example, the product name, the price, the production district, new product information (information indicating that the product is a newly available product), and special information (information indicating that the product is a sales-period-limited product, limited edition, or a premium product). In the following descriptions, the individual items of the display information to be displayed on the display devices 5 may be referred to as “display items”.

The display device 5 stores setting data for the display items and the display patterns (e.g., the display forms, display arrangements, or display formats). The setting data of the display items (hereinafter, also simply referred to as “setting data”) includes data indicating content for a product name field, a price field, a production district field, a new product information field, and a special information field. The setting data is data (information) displayed on the display device 5, and for example, a product name “∘∘” is stored as the setting data of the product name and “×× yen” is stored as the setting data of the price. The server device 4 manages (tracks) a correspondence relationship between the display device 5 and the product (product type) displayed in proximity with the display device 5, and can provide the setting data that is stored in the display device 5 and the setting data values can be input to the server device 4. The display device 5 receives, from the server device 4, the setting data before the store opens. The display device 5 can display the setting data in any display pattern. For example, the display device 5 displays the setting data in a price emphasis pattern that emphasizes the price from among the information related to the product, or displays the setting data in a production district emphasis pattern that emphasizes the production district of the product.

The display device 5 detects a terminal ID and the pattern identification information that are transmitted by the terminal device 6 located within a predetermined range from the display device 5, and displays the product information in the display pattern as indicated by the pattern identification information. The pattern identification information transmitted by the terminal device 6 is selected by the server device 4. Accordingly, the display device 5 can execute display to emphasize the information in which the customer C approaching the display device 5 is deemed highly interested. If there are a plurality of terminal devices 6 that are located within the predetermined range from the display device 5, for example, the display device 5 displays the display information in a display pattern indicated by the largest number of pieces of pattern identification information among the pattern identification information corresponding to the plurality of detected terminal IDs.

The display device 5 may be a multidirectional screen capable of viewing different images depending on the position viewed by the customer C. In this case, the display device 5 includes a unit that acquires the position information corresponding to the terminals ID and recognizes the positions of the terminal devices 6, so that the display device 5 can simultaneously execute a display corresponding to the customers C of the terminal devices 6 at different positions.

The terminal device 6 is, for example, a tablet terminal attached to the shopping cart B. The shopping cart B is provided in a salesroom (sales floor) of the store and is used to transport the product being purchased by the customer C. Therefore, the terminal device 6 provided in the shopping cart B moves together with the customer about the salesroom.

The terminal device 6 includes a scanner (or a camera) and reads the product code of a product with the scanner by an operation of the customer C to register the product for purchase. The product registration is to register (store), in the server device 4 or a storage device of the terminal device 6, the product information (the product name, the price, and the like) of the products to be purchased based on the input product codes. It can be said that the registered product is a product to be purchased by the customer C. The terminal device 6 outputs, to the server device 4, the product code of the product to be purchased by the customer C. That is, the product code of the registered product is sent to server device 4, and the terminal device 6 acquires the corresponding product information from the server device 4.

In some examples, the terminal device 6 may acquire the product identification information on the product to be purchased by acquiring product identification information on the products accommodated in the product accommodation portion of the shopping cart B using a camera, a radio frequency identification (RFID) reader, or the like. For example, the terminal device 6 may acquire the product code by capturing an image of the product in the product accommodation portion of the shopping cart B with a camera, identifying the product based on feature data of the product using an object recognition technique or the like, and thereby recognizing a target product code corresponding to the recognized product. In other examples, the terminal device 6 may acquire the product code by a RFID reader reading the product code stored in an IC tag (RFID tag) that is attached to the product placed in the shopping cart B. In this case, since the terminal device 6 can acquire the product identification information on the product to be purchased even if the customer C does not manually register the product, the display system 3 according to the present embodiment can also be applied to a store using a POS at in which store staff executes an operation related to the product registration and/or the accounting.

Next, the devices constituting the display system 3 will be described. First, the server device 4 will be described.

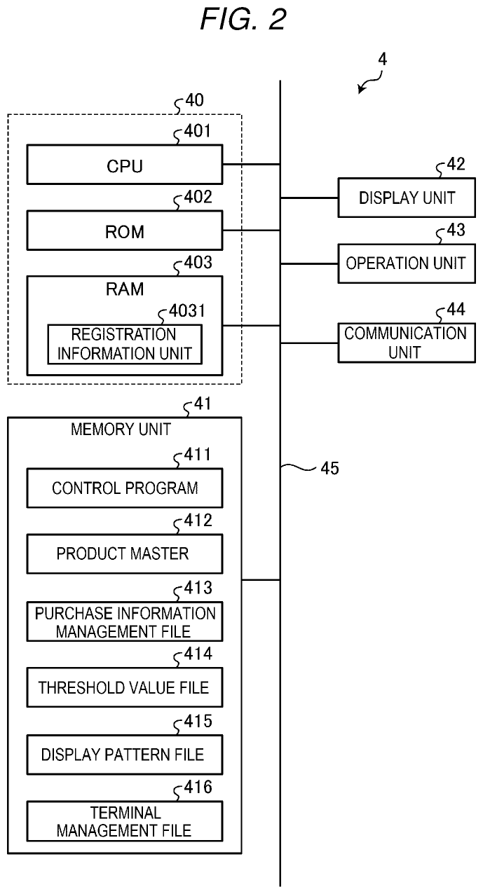

FIG. 2 is a block diagram illustrating a main hardware configuration of the server device 4. The server device 4 includes a control unit 40, a memory unit 41, a display unit 42, an operation unit 43, and a communication unit 44. The control unit 40, the memory unit 41, the display unit 42, the operation unit 43, and the communication unit 44 are connected to one another via a bus 45 or the like.

The control unit 40 is implemented in this example as a computer including a central processing unit (CPU) 401, a read only memory (ROM) 402, and a random access memory (RAM) 403. The CPU 401, the ROM 402, and the RAM 403 are connected to one another via the bus 45.

The CPU 401 controls an entire operation of the server device 4. The ROM 402 stores various types of data and various programs such as programs used for configuring the CPU 401 to perform the various described functions in the present embodiment. The RAM 403 is used as a work area of the CPU 401, and loads various programs and various types of data stored in the ROM 402 and the memory unit 41. The CPU 401 operates according to a control program stored in the ROM 402 or the memory unit 41 and loaded in the RAM 403, so that the control unit 40 executes various types of control for the server device 4.

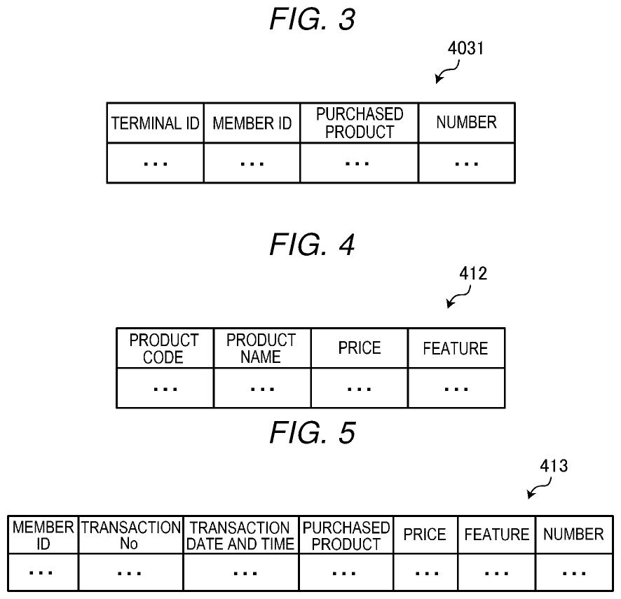

The RAM 403 includes a registration information unit 4031. The registration information unit 4031 stores registration information. In the registration information, information for identifying the terminal device 6, information for identifying the customer C, and information on a product (hereinafter, also referred to as a “purchased product”) to be purchased by the customer C, which are acquired from the terminal device 6 during shopping of the customer C, are all associated with one another. FIG. 3 is a diagram illustrating a data configuration of the registration information unit 4031. Data registered in the registration information unit 4031 is associated with information indicating the terminal ID, a member ID, the purchased product, and the number (quantity).

The terminal ID for identifying the terminal device 6 is registered as an item in the terminal ID column. The terminal ID is an example of the terminal identification information. The member ID of the customer C is registered as an item in the item of the member ID column. The member ID is an example of customer identification information for identifying the customer C. The product code of the purchased product is registered as an item in the item of the purchased product column. When the customer C registers a plurality of types of products during shopping, a plurality of product codes are registered as items in the purchased product column. Information indicating the number (quantity) corresponding to a purchased product code is registered as an item in the number column.

The memory unit 41 includes a storage medium such as a hard disk drive (HDD) or a flash memory, and maintains a storage content even if a power supply is interrupted. The memory unit 41 stores a control program 411, a product master 412, a purchase information management file 413, a threshold value file 414, a display pattern file 415, and a terminal management file 416.

The control program 411 is a software program (application) for implementing functions of acquiring, from the terminal device 6, the terminal ID, the member ID, and the product code; selecting the display pattern of the display device 5 based on the acquired terminal ID and product code; outputting the pattern identification information for identifying the selected display pattern to the terminal device 6, and the like.

The product master 412 is a master file that stores the product information regarding the products sold in the store. Since the products sold in the store might change on a daily basis or the like, the product master 412 can be appropriately updated. The updated product master 412 can be distributed to the terminal device 6. FIG. 4 is a diagram illustrating a data configuration of the product master 412. Data registered in the product master 412 is associated with information indicating the product code, the product name, the price, and a feature (feature value).

The product code for identifying the product is registered as an item in the product code column. The information indicating the name of the product is registered as an item in the product name column. The information indicating a unit price of the product is registered in the as an item in the price column. The unit price of the product may be a base price of the product or a price including consumption tax. The information indicating a specific feature of the product is registered as an item in the feature column. In this context, a “feature” of the product is information about the product that might be appealing to a customer C, and for example, information indicating the “price” in the case of a bargain, the “production district” in the case of a local product, the “new product” in the case of a newly released product, and “special” in the case of a limited-time-only product can be registered in the feature column. The feature of the product corresponds to the display items displayed by the display device 5. Depending on the product, there may be no particular “feature” considered relevant to a customer appeal, thus a null value or the like might be registered in the feature column for a product.

The purchase information management file 413 is a file for managing, for each customer C, the past purchase information of the customer C. The purchase information management file 413 is updated based on the member ID and the accounting information that are included in settlement completion information received from the accounting device 2. FIG. 5 is a diagram illustrating a data configuration of the purchase information management file 413. Data registered in the purchase information management file 413 is associated with information indicating the member ID, a transaction number (No.), a transaction date and time, the purchased product, the price, the feature, and the quantity (number) purchased.

The member ID for identifying a member is registered as an item in the member ID column. The transaction number (transaction ID) for identifying a transaction as an item in the transaction No. column. The information indicating a date and time of the transaction is registered as an item in the transaction date and time column. The product code of a product purchased in the transaction is registered as an item in the purchased product column. When a plurality of products are purchased in one transaction, a plurality of product codes are registered as items in the purchased product column.

The information indicating the unit price of the product is registered as an item in the price column. The information indicating the “feature” of the purchased product is registered as an item in the feature column. The information indicating the number (quantity) of corresponding purchased products is registered as an item in the number column.

The threshold value file 414 is a file that stores a threshold value set for the number of the product codes acquired from the terminal device 6. When the server device 4 selects the display pattern, the threshold value is used to determine whether to select the display pattern based on the past purchase information or based on the information registered during the present shopping.

For example, if the threshold value is set to “5” and the number of the product codes acquired from the terminal device 6 during the present shopping of the customer C is 5 or less, that is, if the number of the product codes registered in the purchased product column of the registration information unit 4031 is 5 or less, the server device 4 selects the display pattern based on the past purchase history of the customer C. If the number of the product codes acquired from the terminal device 6 during the present shopping of the customer C exceeds 5, that is, when the number of the product codes registered in the purchased product column of the registration information unit 4031 exceeds 5, the server device 4 selects the display pattern based on the product codes acquired from the terminal device 6 during the current shopping. The threshold value may be a threshold value related to the total number of the purchased products. In this case, the threshold value is a threshold value for a total of the numbers registered in the number column of the registration information unit 4031. In addition, the threshold value can be set to any value.

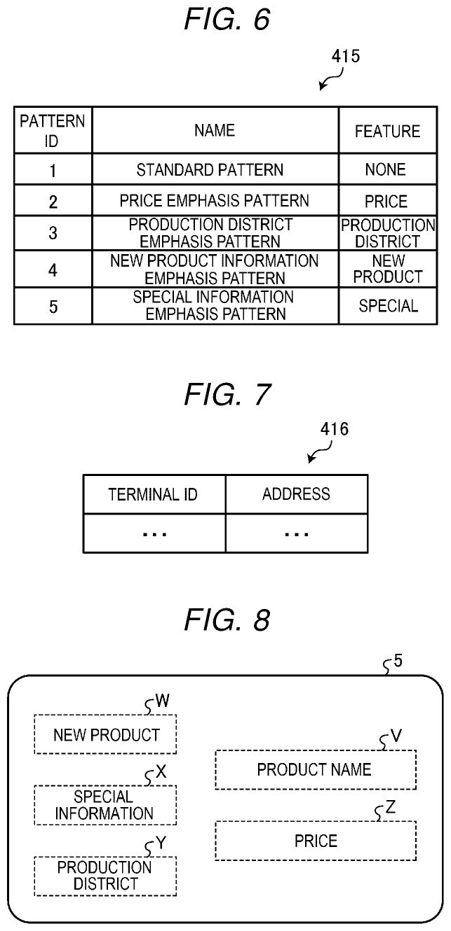

The display pattern file 415 is a file for managing the display patterns and the feature values/types in association with each other. FIG. 6 is a diagram illustrating a data configuration of the display pattern file 415. Data registered in the display pattern file 415 is associated with information indicating a pattern ID, the name of the pattern, and the feature type corresponding to the associated pattern.

In the present embodiment, a standard pattern, a price emphasis pattern, a production district emphasis pattern, a new product information emphasis pattern, and a special information emphasis pattern are set as possible pattern choices. For example, the information (content) indicating the price, the production district, the new product, and special is placed in corresponding pattern field of the display pattern. The possible feature values/type in this context are those registered in the product master 412. Additionally, there is no feature type specifically corresponding to the standard pattern, which is the default pattern.

Here, a display example of the display pattern selected by the server device 4 will be described. FIG. 8 is a diagram illustrating a display example of the standard pattern as executed by the display device 5. In the display device 5, a product name display area V, a new product information display area W, a special information display area X, a production district display area Y, and a price display area Z are provided. Setting data is displayed in the display areas V to Z. Depending on the product, information might not necessarily be displayed in all the available display areas. For example, when the product is not a new product, no data is set in the item of the new product. Therefore, no information is displayed in the new product information display area W. Other information, for example, a store logo may be displayed in the display area for which no data is set.

The display device 5 displays the display information by displaying the setting data in the display pattern selected by the server device 4. For example, if the price emphasis pattern is selected, the display device 5 executes a display to emphasize the price by enlarging the price display area Z or displaying the price display area Z in a color different from that of the other areas. Similarly, for the production district emphasis pattern, the new product information emphasis pattern, or the special information emphasis pattern being selected, the display device 5 executes display in a pattern or manner to emphasize the selected display item.

The terminal management file 416 is a file for managing an address of the terminal device 6. FIG. 7 is a diagram illustrating a data configuration of the terminal management file 416. Data registered in the terminal management file 416 is associated with information indicating the terminal ID and the address.

The terminal ID for identifying the terminal device 6 is registered in the terminal ID column. Address information for identifying a destination address for the terminal device 6, which is an output destination for the display pattern selected by the server device 4, is registered in the address column. In the present embodiment, since the terminal device 6 is a tablet terminal that is managed by the store and attached to the shopping cart B, an IP address of the tablet terminal (terminal device 6) can be set as the address information in advance. When a smartphone or the like of a member in which a shopping application program for the display system 3 has been installed is used as the terminal device 6, address information provided by the customer at the time of member registration can be registered as an item in the address column.

Referring back to FIG. 2, the hardware of the server device 4 will be described. The display unit 42 includes, for example, a liquid crystal panel, and displays various types of information. For example, the display unit 42 displays an input screen for inputting the setting data of the display device 5. The setting data is a generic term for the data regarding the display items (the product name, the new product information, the special information, the production district, and the price).

The operation unit 43 can be used to input the information to the control unit 40. The operation unit 43 includes a keyboard, a touch panel that is provided on a surface of the display unit 42, or the like. For example, the operation unit 43 inputs the setting data for the display device 5 to the control unit 40.

The communication unit 44 is an interface for communicating with external devices such as the accounting device 2, the display device 5, and the terminal device 6. The control unit 40 is connected to the external devices via the communication unit 44 to send and receive the information (the data) to and from the external devices.

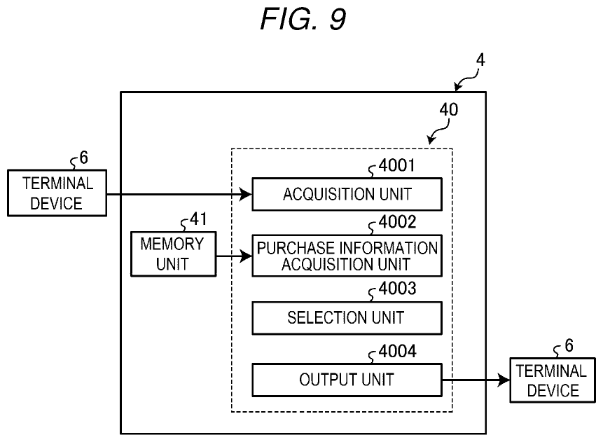

Next, functional aspects of the control unit 40 will be described. FIG. 9 is a block diagram illustrating certain functional aspects of the control unit 40 of the server device 4. The CPU 401 operates according to the control program stored in the ROM 402 or the memory unit 41, so that the control unit 40 functions as an acquisition unit 4001, a purchase information acquisition unit 4002, a selection unit 4003, and an output unit 4004. In other examples, the functions may be implemented by hardware such as a dedicated circuit.

The acquisition unit 4001 acquires, from the terminal device 6 that moves together with the customer C, the terminal identification information for identifying the terminal device 6 and the product identification information for identifying the product to be purchased by the customer C. Specifically, the acquisition unit 4001 acquires, from the terminal device 6, the terminal ID, the member ID input to the terminal device 6, and the product code of the product registered by the terminal device 6. The acquisition unit 4001 acquires, from the terminal device 6, the terminal ID, the member ID, and the product code each time a product is registered by the terminal device 6. Since the acquisition unit 4001 also acquires the member ID, it can be said that the acquisition unit 4001 is an example of a customer information acquisition unit.

The purchase information acquisition unit 4002 acquires the past purchase information of the customer C that is identified according to the customer identification information acquired by the customer identification information acquisition unit. Specifically, the purchase information acquisition unit 4002 acquires, from the purchase information management file 413, the past purchase information (“purchase history”) of the customer C that is identified according to the member ID acquired by the acquisition unit 4001. The purchase information acquisition unit 4002 may acquire the purchase information from the purchase information management file stored in an external memory.

The selection unit 4003 selects any one of the predetermined display patterns based on the product identification information acquired by the acquisition unit 4001. Specifically, the selection unit 4003 selects a display pattern from the display patterns stored in the display pattern file 415 using the feature information corresponding to the product code acquired by the acquisition unit 4001.

For example, the selection unit 4003 selects the display pattern according to the following selection method. When the acquisition unit 4001 acquires a plurality of product codes (the total number of product codes exceeding the threshold value in the present embodiment) the selection unit 4003 reads the feature information corresponding to each product code from the product master 412, and identifies the most common feature information type among the read feature information. Next, the selection unit 4003 refers to the display pattern file 415, and selects a display pattern corresponding to the identified most common feature information type. That is, the selection unit 4003 selects, based on the purchased products of the customer C, a display feature/item in which the customer C is considered to be highly interested, and selects the display pattern that emphasizes the selected display feature/item.

The method for selecting the display pattern by the selection unit 4003 is not limited to the above. For example, the selection unit 4003 may select the display pattern by a machine learning approach using the product codes acquired by the acquisition unit 4001 as an input. In this case, it is possible to perform questionnaire research for the customer C about the interested item features (the price, the production district, the new product, special, and the like), and use learning data in which the purchase information of the customer C is the input data and a questionnaire result is treated as the “correct” answer data.

The selection unit 4003 selects the display pattern based on the product identification information acquired by the acquisition unit 4001 and the purchase information acquired by the purchase information acquisition unit 4002. Specifically, if the number of the product codes acquired by the acquisition unit 4001 is equal to or less than the threshold value registered in the threshold value file 414, the selection unit 4003 selects the display pattern based on the purchase information acquired by the purchase information acquisition unit 4002. If the number of the purchased products of the customer C is small, it is considered that the selection accuracy is low when the feature in which the customer C is interested is selected based on the purchased products. Therefore, the feature in which the customer C is interested is selected based on the past purchase information when available. The method for selecting the display pattern based on the past purchase information can be the same as the method for selecting the display pattern based on the product codes acquired by the acquisition unit 4001 in the present shopping.

If the number of the product codes acquired by the acquisition unit 4001 exceeds the threshold value registered in the threshold value file 414, the selection unit 4003 selects the display pattern based on the product codes acquired by the acquisition unit 4001 in the present shopping. Since it is considered that the information in which the customer C is interested might change on a daily basis or otherwise be time dependent, it is possible to execute a selection that matches the demonstrated current interest of the customer C by selecting a feature in which the customer C appears to be presently interested in based on the purchased products during the present shopping. The concept that the selection unit 4003 selects the display pattern includes selection of a pattern ID.

The output unit 4004 outputs, to the terminal device 6 identified according to the terminal identification information acquired by the acquisition unit 4001, the pattern identification information for identifying the display pattern selected by the selection unit 4003. Specifically, the output unit 4004 reads the IP address corresponding to the terminal ID acquired by the acquisition unit 4001 from the terminal management file 416, and outputs, using the read IP address as the output destination, the pattern ID selected by the selection unit 4003. In addition, the output unit 4004 outputs various types of information to the accounting device 2, the display device 5, and the terminal device 6.

Next, the display device 5 will be described.

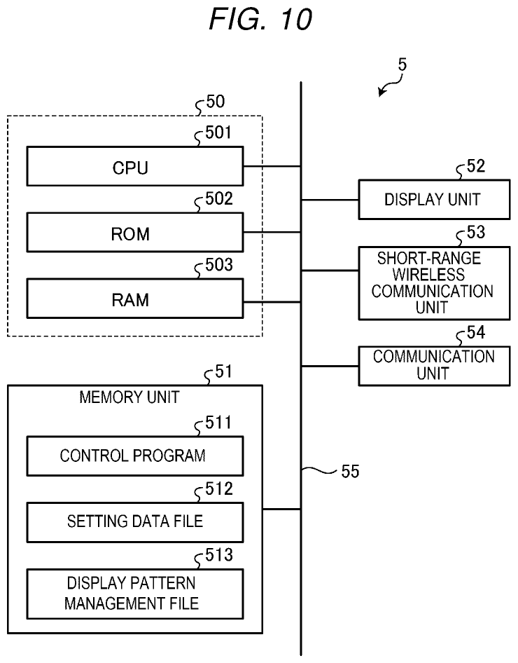

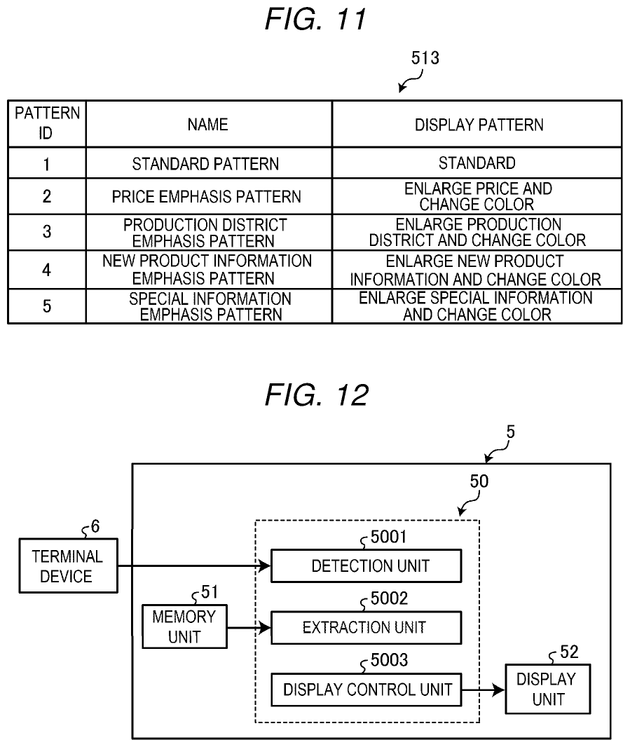

FIG. 10 is a block diagram illustrating a main hardware configuration of the display device 5. The display device 5 includes a control unit 50, a memory unit 51, a display unit 52, a short-range wireless communication unit 53, and a communication unit 54. The control unit 50, the memory unit 51, the display unit 52, the short-range wireless communication unit 53, and the communication unit 54 are connected to one another via a bus 55 or the like.

The control unit 50 is implemented as a computer including a CPU 501, a ROM 502, and a RAM 503. The CPU 501, the ROM 502, and the RAM 503 are connected to one another via the bus 55.

The CPU 501 controls an entire operation of the display device 5. The ROM 502 stores various types of data and various programs such as programs used for driving the CPU 501. The RAM 503 is used as a work area of the CPU 501, and loads various programs and various types of data that are stored in the ROM 502 and the memory unit 51. The CPU 501 operates according to a control program stored in the ROM 502 or the memory unit 51 and loaded in the RAM 503, so that the control unit 50 executes various types of control for the display device 5.

The memory unit 51 includes a storage medium such as an HDD or a flash memory, and maintains the storage content even if the power supply is interrupted. The memory unit 51 stores a control program 511, a setting data file 512, and a display pattern management file 513.

The control program 511 is a software program or the like for implementing a function of detecting the terminal ID and the pattern ID that are transmitted by the terminal device 6 located within a predetermined range from the display device 5, and a function of displaying the product information based on the detected terminal ID and pattern ID.

The setting data file 512 stores the setting data received from the server device 4. The setting data is data related to the product name, the new product information, the special information, the production district, and the price that are displayed on the display unit 52. Depending on the display device 5, the data related to any item type may not be included. For example, in the case of the display device 5 corresponding to a product that is not a new product, data is not registered in the new product information field or the like.

The display pattern management file 513 stores the display pattern for the setting data to be displayed on the display unit 52. FIG. 11 is a diagram illustrating a data configuration of the display pattern management file 513. The data registered in the display pattern management file 513 is associated with the information indicating the pattern ID, the name, and the display pattern.

The registered display patterns include, in addition to the standard pattern shown in FIG. 8, the price emphasis pattern, the production district emphasis pattern, the new product information emphasis pattern, and the special information emphasis pattern.

The display unit 52 includes, for example, a liquid crystal panel, and displays the display information. The display unit 52 displays the display information by displaying the data stored in the setting data file 512 in one of the display patterns stored in the display pattern management file 513.

The short-range wireless communication unit 53 communicates with the terminal device 6 by short-range wireless communication such as Bluetooth®. If the terminal device 6 is located in a receivable range (a predetermined range) in which communication can be executed by short-range wireless communication, the short-range wireless communication unit 53 receives the information including the terminal ID and the pattern ID transmitted by the terminal device 6. For example, the receivable range is set to a range of 1 meter to 2 meters from the display device 5. The receivable range can be set to any appropriate value.

The communication unit 54 is an interface for communicating with an external device such as the server device 4. The control unit 50 is connected to the external device via the communication unit 54 to send and receive information (data) to and from the external device.

Next, functional aspects of the control unit 50 will be described. FIG. 12 is a block diagram illustrating the functional configuration of the control unit 50 of the display device 5. The CPU 501 operates according to the control program stored in the ROM 502 or the memory unit 51, so that the control unit 50 functions as a detection unit 5001, an extraction unit 5002, and a display control unit 5003. The functions may be implemented by hardware such as a dedicated circuit.

The detection unit 5001 detects the pattern identification information output by a terminal device 6 located within the predetermined range. Specifically, the detection unit 5001 detects the pattern ID and the terminal ID that are transmitted by the terminal device 6 located in the receivable range. In other words, as the terminal device 6 approaches the display device 5 the detection unit 5001 detects the information being output (by short range wireless communication) from the terminal device. More particularly, detection unit 5001 detects the pattern ID and the terminal ID based on the information received by the short-range wireless communication unit 53.

The extraction unit 5002 extracts, from the predetermined display patterns, the display pattern matching the pattern identification information detected by the detection unit 5001. Specifically, the extraction unit 5002 extracts, from the display pattern management file 513, the display pattern corresponding to the pattern ID detected by the detection unit 5001.

The display control unit 5003 displays the display information on the display unit 52 in the display pattern extracted by the extraction unit 5002. Specifically, the display control unit 5003 displays the setting data stored in the setting data file 512 on the display unit 52 in the display pattern extracted by the extraction unit 5002.

Next, the terminal device 6 will be described.

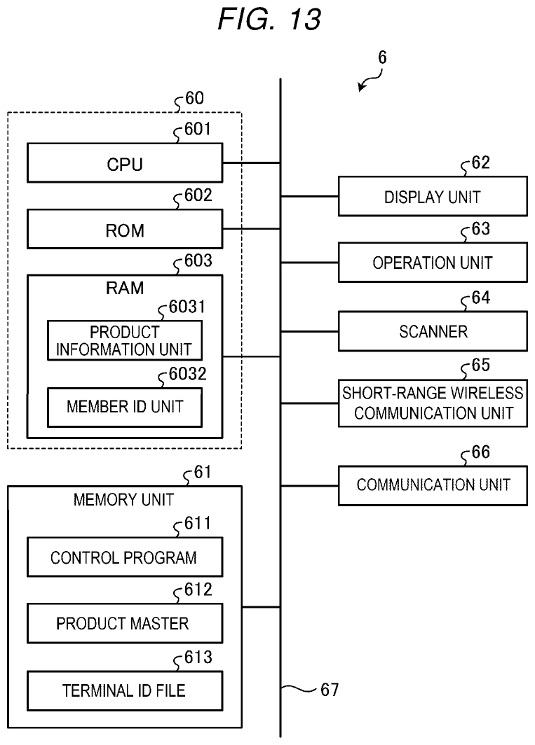

FIG. 13 is a block diagram illustrating a main hardware configuration of the terminal device 6. The terminal device 6 includes a control unit 60, a memory unit 61, a display unit 62, an operation unit 63, a scanner 64, a short-range wireless communication unit 65, and a communication unit 66. The control unit 60, the memory unit 61, the display unit 62, the operation unit 63, the scanner 64, the short-range wireless communication unit 65, and the communication unit 66 are connected to one another via a bus 67 or the like.

The control unit 60 is implemented as a computer including a CPU 601, a ROM 602, and a RAM 603. The CPU 601, the ROM 602, and the RAM 603 are connected to one another via the bus 67.

The CPU 601 controls an entire operation of the terminal device 6. The ROM 602 stores various types of data and various programs such as programs used for driving the CPU 601. The RAM 603 is used as a work area of the CPU 601, and loads various programs and various types of data that are stored in the ROM 602 and the memory unit 61. The CPU 601 operates according to a control program stored in the ROM 602 or the memory unit 61 and loaded in the RAM 603, so that the control unit 60 executes various types of control for the terminal device 6.

The RAM 603 includes a product information unit 6031 and a member ID unit 6032. The product information unit 6031 stores the product information related to the product codes read by the scanner 64. The product information is stored in the product information unit 6031 to register the product. The member ID unit 6032 stores the member ID input to the operation unit 63 or read by the scanner 64.

The memory unit 61 includes a storage medium such as an HDD or a flash memory, and maintains a storage content even if a power supply is interrupted. The memory unit 61 stores a control program 611, a product master 612, and a terminal ID file 613.

The control program 611 is a software program or the like for implementing functions of registering the product; sending the product code of the registered product, the member ID, and the terminal ID to the server device 4; receiving the pattern ID from the server device 4; transmitting the information including the pattern ID received from the server device 4 and the terminal ID by short-range wireless communication; and transmitting the product information stored in the product information unit 6031 as accounting information to the accounting device 2.

The product master 612 is received from the server device 4. Details of the product master corresponds to the product master 412 of the server device 4, and thus redundant descriptions thereof will be omitted. The terminal ID file 613 stores the terminal ID of the terminal device 6 itself.

The display unit 62 includes, for example, a liquid crystal panel, and displays various types of information. For example, the display unit 62 displays the product information on the registered product. In addition, the display unit 62 displays a registration screen for registering a product to which a barcode is not attached.

The operation unit 63 is used to input the information to the control unit 60, and includes a touch panel or the like provided on the surface of the display unit 62. For example, the operation unit 43 inputs, to the control unit 60, the product code of the product to which a barcode is not attached.

The scanner 64 reads the product code from a code symbol, such as a barcode, attached to the product and inputs the product code to the control unit 60. The scanner 64 may also read the member ID from a code symbol on a member card owned by the customer C and inputs the member ID to the control unit 60. The scanner 64 may be an imaging unit such as a camera in some examples.

The short-range wireless communication unit 65 communicates with the display device 5 by short-range wireless communication. The short-range wireless communication unit 65 periodically transmits the information including the pattern ID received from the server device 4 and the terminal ID.

The communication unit 66 is an interface for communicating with external devices such as the accounting device 2 and the server device 4. The control unit 60 is connected to the external device via the communication unit 66 to send and receive the information (the data) to and from the external device.

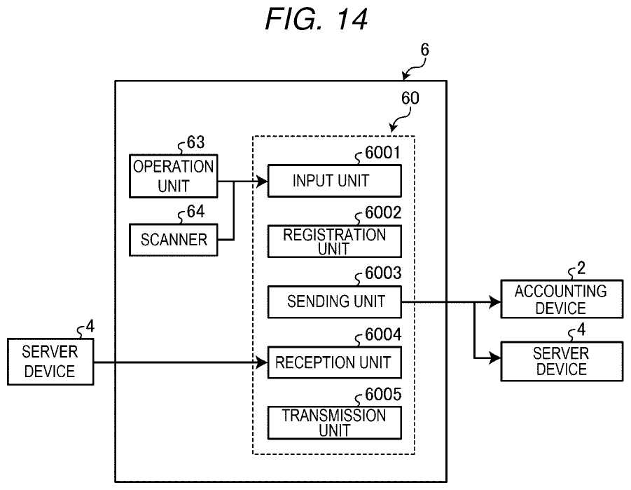

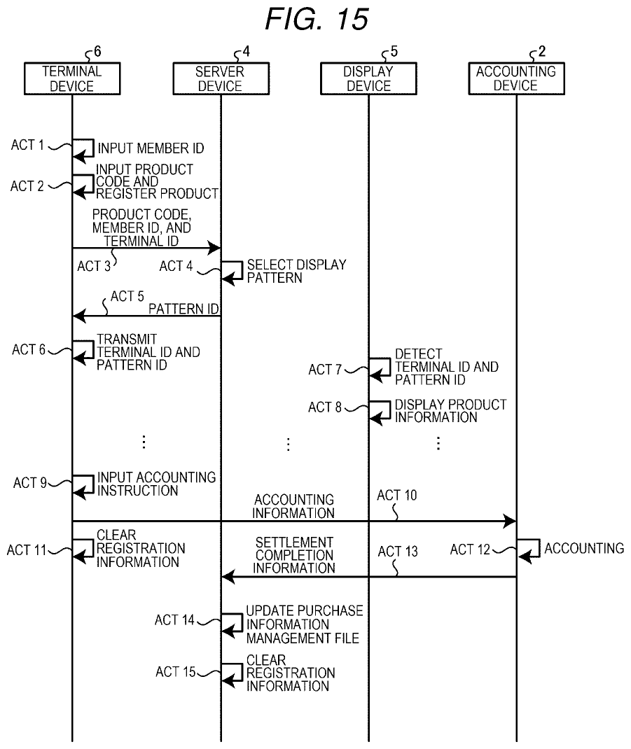

FIG. 14 is a block diagram illustrating functional aspects of the control unit 60 of the terminal device 6. The CPU 601 operates according to a control program stored in the ROM 602 or the memory unit 61, so that the control unit 60 functions as an input unit 6001, a registration unit 6002, a sending unit 6003, a reception unit 6004, and a transmission unit 6005. The functions may be implemented by hardware such as a dedicated circuit.

Various types of information are input to the input unit 6001 from the operation unit 63 and the scanner 64. For example, transaction start information, accounting instruction information, and the product code are input to the input unit 6001 from the operation unit 63. In addition, the product code, the member ID, and the like are input to the input unit 6001 from the scanner 64.

The registration unit 6002 registers the product. Specifically, the registration unit 6002 reads, from the product master 612, the product information (such as the product name and the price) associated with the product code input to the input unit 6001. Then, the registration unit 6002 registers the product information in the product information unit 6031. The product information registered in the product information unit 6031 includes the product code.

When the product code is input to the input unit 6001, the registration unit 6002 may output an inquiry for the product information based on the product code to the server device 4 (storing the product master 412) and acquire the product information from the server device 4. In this case, the memory unit 61 may not need to store the product master 612.

The sending unit 6003 sends, to the server device 4, the product code and the member ID, as well as the terminal ID stored in the terminal ID file. Every time the registration unit 6002 registers a product, the sending unit 6003 sends, to the server device 4, the product code of the registered product, along with the member ID and the terminal ID in association with one another. In addition, when accounting instruction information is input to the input unit 6001, the sending unit 6003 sends the accounting information (the information registered in the product information unit 6031) to the accounting device 2. The sending unit 6003 may send the accounting information and the transaction identification information to the server device 4 in association with each other. In this case, the terminal device 6 encodes the transaction identification information and displays the transaction identification information on the display unit 62. The accounting device 2 can read the transaction identification information from the terminal device 6, acquire the accounting information corresponding to the transaction identification information from the server device 4, and execute accounting.

The reception unit 6004 receives the pattern ID from the server device 4. The pattern ID is a pattern ID indicating the display pattern selected by the server device 4 based on the product code or the terminal ID sent by the sending unit 6003.

When the reception unit 6004 receives the pattern ID from the server device 4, the transmission unit 6005 periodically transmits the information including the pattern ID and the terminal ID from the short-range wireless communication unit 65. The transmission unit 6005 periodically transmits the information including the pattern ID and the terminal ID until the reception unit 6004 receives a different pattern ID from the server device 4. The transmission unit 6005 may transmit the accounting information from the short-range wireless communication unit 65 when the accounting instruction information is input to the input unit 6001. In other words, the terminal device 6 may output the accounting information to the accounting device 2 by short-range wireless communication.

An operation of the store system 1 based on the above configuration will be described. FIG. 15 is a sequence chart illustrating the flow of the operation of the store system 1.

When the customer C begins shopping, the member ID is input to the terminal device 6 (ACT 1). When the product code of a purchased product is read by the scanner 64 while the customer C is shopping, the terminal device 6 registers the product (ACT 2). The terminal device 6 sends, to the server device 4, the product code of the registered product, the input member ID, and the terminal ID (ACT 3).

The server device 4 executes display pattern selection to select a display pattern (ACT 4). During the display pattern selection, if the number of the product codes received from the terminal device 6 in the present shopping is equal to or less than the threshold value, the display pattern is selected based on the past purchase information of the customer C identified according to the member ID. Once the number of the product codes received from the terminal device 6 exceeds the threshold value, the display pattern is selected based on the product code received from the terminal device 6. The server device 4 sends the pattern ID indicating the selected display pattern to the terminal device 6 (ACT 5).

The terminal device 6 now transmits (broadcasts) the information including the terminal ID and the received pattern ID by short-range wireless communication (ACT 6).

When the terminal device 6 is located within the receivable range of a display device 5, the display device 5 can receive the broadcasted information and detect the terminal ID and the pattern ID that are included in the information (ACT 7). The display device 5 then executes processing to display information according to the pattern ID (ACT 8). Thereafter, operations in ACT 2 to ACT 8 are repeatedly performed.

When the customer C executes a payment, the accounting instruction information is input to the terminal device 6 (ACT 9). When the accounting instruction information is input, the terminal device 6 sends the accounting information to the accounting device 2 (ACT 10). At this time, the terminal device 6 may send the accounting information and the transaction identification information to the server device 4 in association with each other. In this case, the terminal device 6 encodes the transaction identification information and displays the transaction identification information on the display unit 62. The accounting device 2 can read the transaction identification information from the terminal device 6, acquire the accounting information corresponding to the transaction identification information from the server device 4, and execute accounting. Next, the terminal device 6 clears the registration information registered in the product information unit 6031 and the member ID unit 6032 (ACT 11).

The accounting device 2 executes accounting based on the received accounting information (ACT 12). The accounting is processing for the customer C to pay the purchase price, and is processing related to cash settlement, cashless settlement, or the like. When the accounting is completed, the accounting device 2 sends the settlement completion information to the server device 4 (ACT 13). The settlement completion information includes the member ID of the customer C and the accounting information.

The server device 4 updates the purchase information management file 413 based on the member ID and the accounting information that are included in the received settlement completion information (ACT 14). Then, the server device 4 clears the registration information related to the member ID included in the settlement completion information among the information registered in the registration information unit 4031 (ACT 15).

Next, the display pattern selection executed by the server device 4 will be described. FIG. 16 is a flowchart illustrating a flow of the display pattern selection executed by the control unit 40 of the server device 4.

First, the selection unit 4003 determines whether the acquisition unit 4001 has acquired a product code, terminal ID, and member ID from the terminal device 6 (ACT 21), and when the acquisition unit 4001 does not acquire the product code, the terminal ID, and the member ID (No in ACT 21), the selection unit 4003 returns to ACT 21 and waits.

When the acquisition unit 4001 acquires the product code, the terminal ID, and the member ID from the terminal device 6 (Yes in ACT 21), the selection unit 4003 registers the acquired information in the registration information unit 4031 (ACT 22), and determines whether the product codes associated with the terminal ID in the present shopping as acquired by the acquisition unit 4001 exceeds a predetermined number (ACT 23). More specifically, in ACT 23, the selection unit 4003 refers to the registration information unit 4031, and determines whether the product codes registered corresponding to the terminal ID acquired by the acquisition unit 4001 exceeds the threshold value registered in the threshold value file 414.

If the number of the product codes corresponding to the terminal ID acquired by the acquisition unit 4001 exceeds the predetermined number (Yes in ACT 23), the selection unit 4003 selects a display pattern based on the product codes acquired by the acquisition unit 4001 (ACT 24). Then, the control unit 40 ends the display pattern selection.

If the number of the product codes corresponding to the terminal ID acquired by the acquisition unit 4001 is still equal to or less than the predetermined number (No in ACT 23), the purchase information acquisition unit 4002 acquires the purchase information (ACT 25). The purchase information acquisition unit 4002 reads, from the purchase information management file 413, the purchase information corresponding to the member ID acquired by the acquisition unit 4001. Next, the selection unit 4003 selects a display pattern based on the purchase information acquired by the purchase information acquisition unit 4002 (ACT 26). Then, the control unit 40 ends the display pattern selection. Thereafter, as illustrated in ACT 5 in FIG. 15, the server device 4 sends the pattern ID of the display pattern selected in the display pattern selection to the terminal device 6.

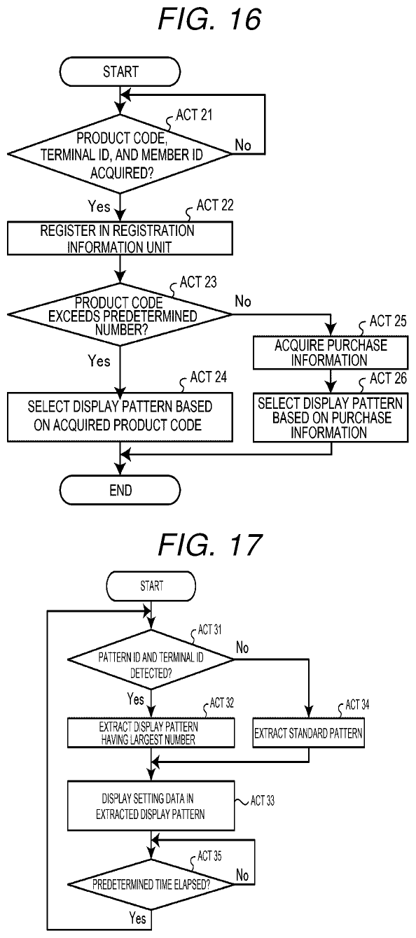

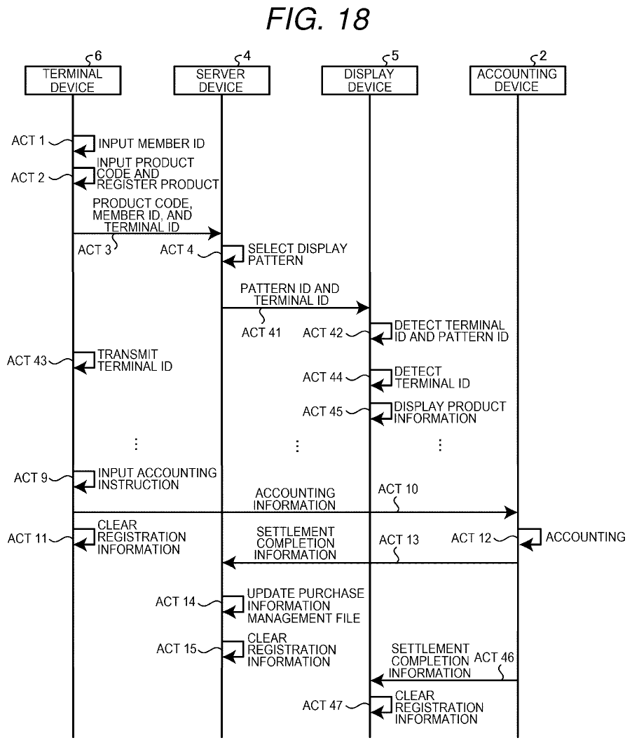

Next, the display information display executed by the display device 5 will be described. FIG. 17 is a flowchart illustrating a flow of the display information display executed by the control unit 50 of the display device 5.

The control unit 50 determines whether the detection unit 5001 detects one or more pattern IDs and terminal IDs transmitted by the terminal device 6 (ACT 31). When one or more pattern IDs and terminal IDs are detected by the detection unit 5001 (Yes in ACT 31), the extraction unit 5002 extracts, from the display pattern management file 513, a display pattern for a pattern ID with which the largest number terminal IDs detected by the detection unit 5001 is associated (ACT 32). If the number of the terminal IDs detected by the detection unit 5001 is just one, the extraction unit 5002 extracts, from the display pattern management file 513, the display pattern of the pattern ID associated with the single detected terminal ID.

The display control unit 5003 displays the setting data stored in the setting data file 512 on the display unit 52 in the display pattern extracted by the extraction unit 5002 (ACT 33). In ACT 31, if the detection unit 5001 does not detect the pattern ID and the terminal ID (No in ACT 31), the extraction unit 5002 extracts the standard pattern from the display pattern management file 513 (ACT 34). Then, the control unit 50 proceeds to ACT 33.

The display control unit 5003 determines whether a predetermined time elapses since the display was executed in ACT 33 (ACT 35). The predetermined time is, for example, 10 seconds, but can be set to any time.

When the predetermined time elapses (Yes in ACT 35), the control unit 50 returns to ACT 31, but if the predetermined time has not yet elapsed (No in ACT 35), the control unit 50 returns to ACT 35 and waits. Accordingly, the display device 5 can change the display pattern of the product information at predetermined time intervals.

In ACT 32, if the data of the feature to be emphasized by the display pattern corresponding to the largest number of pattern IDs is not registered, the extraction unit 5002 extracts the standard pattern. For example, when the largest number of pattern ID is for the new product information emphasis pattern, if data is not registered for the new product information in the setting data file 512 (e.g., if the product corresponding to the display device 5 is not a new product), the extraction unit 5002 extracts the standard pattern. In other examples, the extraction unit 5002 may extract any display pattern corresponding to the detected pattern IDs, for example, extract the display pattern corresponding to the second largest number of pattern IDs.

As described above, according to the display system 3 in the first embodiment, the display device 5 can display the product information in a display pattern to emphasize a feature considered to be important (highly interesting) to the customer C approaching the predetermined range. Accordingly, it is possible to execute a display to attain an appealing effect for the customer C.

According to the display system 3, the display device 5 displays the display information based on the past purchase information of the customer C if the number of the purchased products of the customer C is equal to or less than a predetermined number, and displays the display information based on the purchased products when the number of the purchased products of the customer C exceeds the predetermined number. In other words, when the number of the purchased products is small and it would be difficult to estimate a particular feature in which the customer C is interested, the display device 5 displays the display information based on the past purchase information of the customer C. Accordingly, the display system 3 can execute further adapt displays to emphasize features in which the customer C is likely interested.

Further, according to the display system 3, if there are a plurality of terminal devices 6 located within the predetermined range, in other words, if there are a plurality of customers C near the display device 5, the display device 5 can execute a display to emphasize a feature in which the largest number of customers C is interested.

### Second Embodiment

The second embodiment is different from the first embodiment in that the display device 5 receives a pattern ID and a terminal ID from the server device 4 and stores the pattern ID and the terminal ID, and that the display device 5 detects the terminal ID transmitted by the terminal device 6 and displays the product information based on the corresponding pattern ID. Hereinafter, descriptions of configurations and functions similar to those according to the first embodiment may be omitted to avoid unnecessary redundancy of the following descriptions and to facilitate understanding of those skilled in the art.

The operation of the store system 1 according to the second embodiment will be described. FIG. 18 is a sequence chart illustrating the flow of the operation of the store system 1. The same processing as those in the sequence chart according to the first embodiment illustrated in FIG. 15 are denoted by the same reference numerals, and detailed descriptions thereof will be omitted.

The processing from ACT 1 to ACT 4 is the same as the processing according to the first embodiment. The server device 4 sends, to the display device 5, the pattern ID of the display pattern selected in the display pattern selection and the terminal ID received from the terminal device 6 (ACT 41).

The display device 5 stores the pattern ID and the terminal ID that are received from the server device 4 in the RAM 503 in association with each other (ACT 42). The terminal device 6 transmits the terminal ID (ACT 43). After the member ID is input in ACT 1, the terminal device 6 periodically transmits the terminal ID.

The display device 5 detects the terminal ID transmitted by the terminal device 6 located within the receivable range (ACT 44). The display device 5 executes the display information display and executes display based on the detected terminal ID (ACT 45).

The subsequent ACT 9 to ACT 15 are the same as those according to the first embodiment. In the second embodiment, the accounting device 2 also sends the settlement completion information to the display device 5 (ACT 46). The settlement completion information also includes the terminal ID included in the accounting information received by the accounting device 2 in ACT 10. The display device 5 clears the registration information (the information stored in ACT 42) related to the terminal ID included in the received settlement completion information (ACT 47). Even before receiving the settlement completion information from the accounting device 2, the display device 5 may clear the registration information related to the terminal ID when a predetermined time elapses since the first reception of the terminal ID.

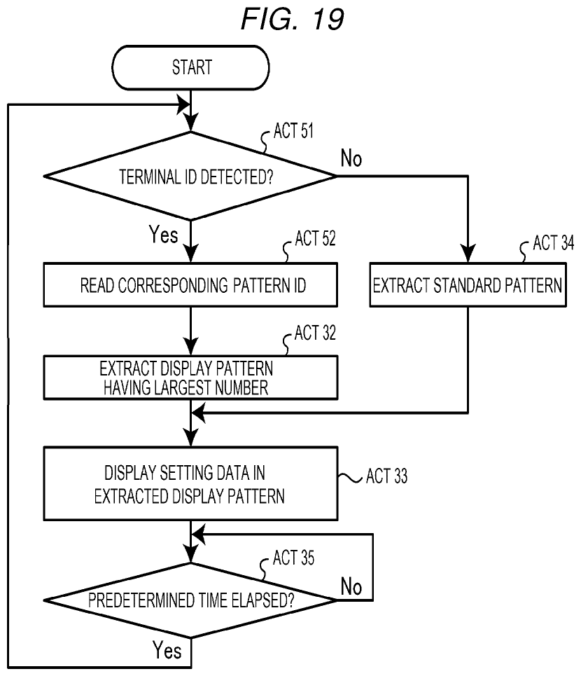

Next, the display information display according to the second embodiment will be described. FIG. 19 is a flowchart illustrating a flow of the display information display executed by the control unit 50 of the display device 5 according to the second embodiment. The same processing as that in the display information display according to the first embodiment illustrated in FIG. 17 is denoted by the same reference numerals, and the descriptions thereof will be omitted.

The control unit 50 determines whether the detection unit 5001 detects one or more terminal IDs transmitted by terminal devices 6 (ACT 51). If the detection unit 5001 detects one or more terminal IDs (Yes in ACT 51), the extraction unit 5002 reads the pattern IDs corresponding to the one or more terminal IDs detected by the detection unit 5001 from the information in which the terminal ID and the pattern ID stored in the RAM 503 are associated with each other (ACT 52). The other processing is the same as product information generation according to the first embodiment.

According to the second embodiment described above, the following effects are attained as in the first embodiment. The display device 5 can display the product information in the display pattern to emphasize a feature (or piece of information) in which the approaching customer C is considered to be highly interested. In addition, the display system 3 can execute display to further adapt to change the feature/item in which the customer C is interested when additional information regarding customer C's interests are acquired. Further, when there are a plurality of customers C near the display device 5, it is possible to execute display to emphasize an aspect in which the largest number of customers C (among those near the display device 5) appear interested.

### Third Embodiment

In the third embodiment, the server device 4 obtains position information of the terminal device 6 with respect to the display device 5, and when the server device 4 recognizes that the terminal device 6 approaches the display device 5, the server device 4 outputs display data to the display device 5. The display data is data for displaying the product information on the display device 5, and is data generated based on setting data and a display pattern according to apparent customer interest. In the following descriptions, descriptions of configurations and functions similar to those according to the first embodiment may be omitted.

In the third embodiment, beacon devices that execute short-range wireless communication with the terminal device 6 are provided in the product display shelves A. Since the product display shelves A are provided with a plurality of display devices 5, the beacon devices are associated with the display devices 5. The beacon device transmits a beacon ID for identifying the beacon device. The beacon device may be provided at a portion other than the product display shelf A. In this case, the server device 4 can recognize the position information of the terminal device 6 in more detail. The server device 4 may recognize the position of the terminal device 6 using a global positioning system (GPS) technique.

When the terminal device 6 is located within a predetermined range from the product display shelf A, that is, within a receivable range of the beacon ID, the terminal device 6 receives the beacon ID. The terminal device 6 sends, to the server device 4, the received beacon ID and the terminal ID for identifying the terminal device.

The server device 4 identifies the display device 5 at which the terminal device 6 is located based on the received beacon ID and terminal ID. In addition, as in the first embodiment, the server device 4 acquires, from the terminal device 6, information in which the product code of the purchased product, the terminal ID, and the member ID are associated with one another, and selects a display pattern. The server device 4 sends the display data corresponding to the selected display pattern to the display device 5 from which the terminal device 6 is located within the predetermined range. The display device 5 displays the received display data.

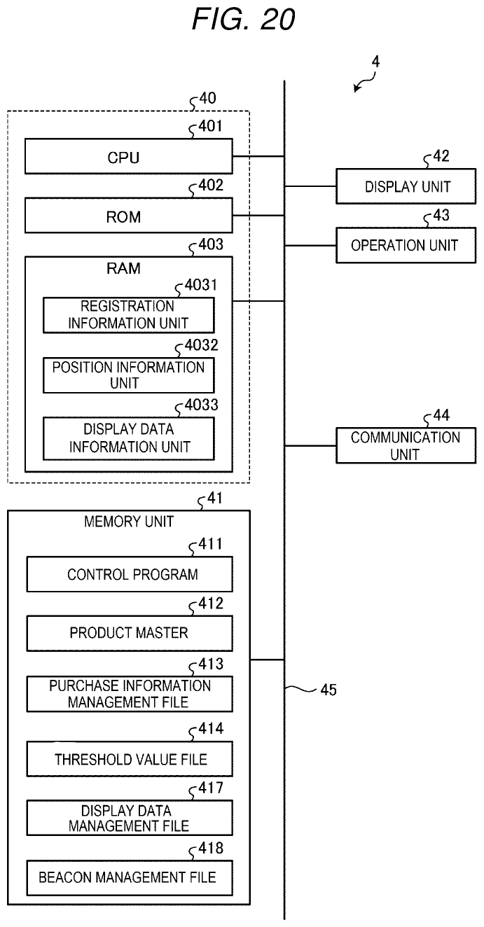

The server device 4 will be described. FIG. 20 is a block diagram illustrating a hardware configuration of the server device 4. In the third embodiment, the RAM 403 also includes a position information unit 4032 and a display data information unit 4033.

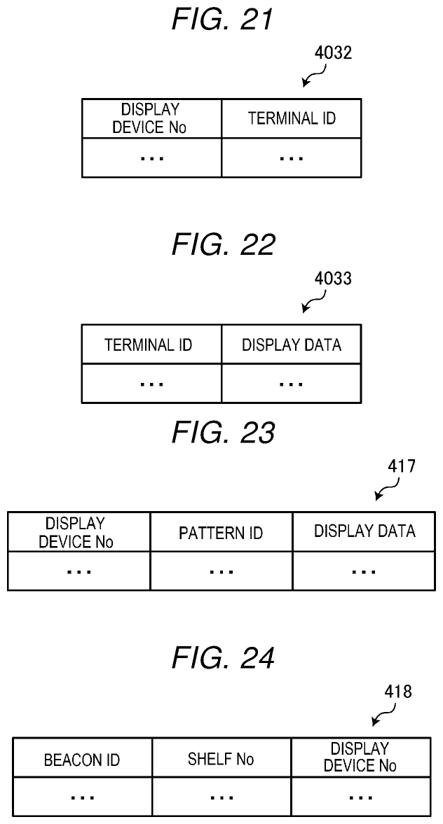

The position information unit 4032 manages, for each display device 5, the terminal device 6 located within the predetermined range of the display device 5. The position information unit 4032 is updated according to the beacon ID and the terminal ID that are periodically received by the server device 4 from the terminal device 6, and manages the terminal device 6 located at the position of the display device 5 in real time. If the terminal device 6 is not located within the receivable range of any display device 5, the terminal device 6 merely sends the terminal ID. If the server device 4 merely receives the terminal ID, the server device 4 determines that the terminal device 6 identified according to the terminal ID is not located near any display device 5, and updates the position information unit 4032. FIG. 21 is a diagram illustrating a data configuration of the position information unit 4032. Data registered in the position information unit 4032 is associated with a display device No and the terminal ID.

The number for identifying the display device 5 is registered in the display device No column. The terminal ID for identifying the terminal device 6 is registered in the terminal ID column.

The display data information unit 4033 manages the display data selected as being suitable for each terminal device 6 at the present time. The display data information unit 4033 stores the terminal device 6 and the display data selected when the terminal device 6 approaches the display device 5 in association with each other. If a plurality of terminal devices 6 are located in the display device 5, the information stored in the display data information unit 4033 is used to determine which type of display data corresponds to the interests of the most the terminal devices 6. The display data information unit 4033 is updated every time the display data corresponding to the terminal device 6 is selected. FIG. 22 is a diagram illustrating a data configuration of the display data information unit 4033. Data registered in the display data information unit 4033 is associated with the terminal ID and the display data.

The memory unit 41 also stores a display data management file 417 and a beacon management file 418.

The display data management file 417 is a file that manages the display data to be displayed on the display device 5. FIG. 23 is a diagram illustrating a data configuration of the display data management file 417. Data registered in the display data management file 417 is associated with information indicating the display device No, the pattern ID, and the display data.

The beacon management file 418 is a file that manages the correspondence relation between the beacon devices and the display devices 5. FIG. 24 is a diagram illustrating a data configuration of the beacon management file 418. Data registered in the beacon management file 418 is associated with information indicating the beacon ID, a shelf No, and the display device No.

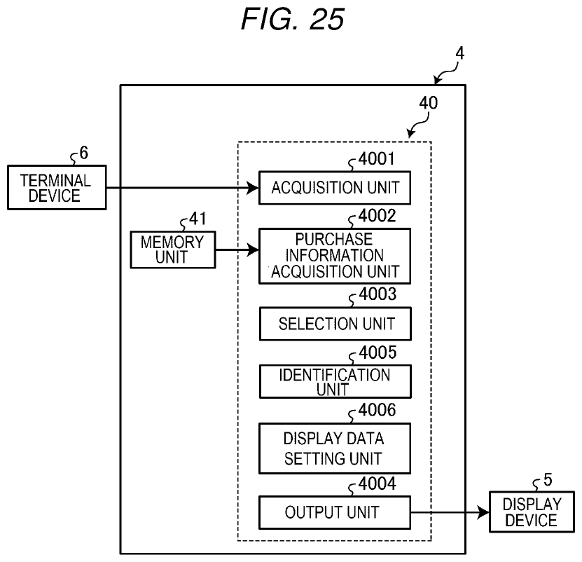

FIG. 25 is a block diagram illustrating functional aspects of the control unit 40 of the server device 4. The CPU 401 operates according to the control program stored in the ROM 402 or the memory unit 41, so that the control unit 40 functions as the acquisition unit 4001, the purchase information acquisition unit 4002, the selection unit 4003, the output unit 4004, an identification unit 4005, and a display data setting unit 4006. In some examples, these functions may be implemented by hardware such as a dedicated circuit.

In addition to the functions according to the first embodiment, the acquisition unit 4001 acquires, from the terminal device 6, the position information in which the terminal ID and the beacon ID are associated with each other. The functions of the purchase information acquisition unit 4002 and the selection unit 4003 are the same as those according to the first embodiment.

The identification unit 4005 identifies, based on the position information acquired by the acquisition unit 4001, the display device 5 at which the terminal device 6 identified according to the terminal ID included in the position information is located. Specifically, the identification unit 4005 refers to the beacon management file 418 and reads the display device No corresponding to the beacon ID included in the position information acquired by the acquisition unit 4001. The identification unit 4005 identifies, as the display device 5 at which the terminal device 6 identified according to the terminal ID acquired by the acquisition unit 4001 is located, the display device 5 identified according to the read display device No.

The display data setting unit 4006 sets the display data to be output to the display device 5 as identified by the identification unit 4005. Specifically, the display data setting unit 4006 refers to the display data management file 417 and selects the display data corresponding to the display device No identified by the identification unit 4005 and the pattern ID selected by the selection unit 4003. In other words, the display data setting unit 4006 selects the display data to emphasize the items in which the customer C approaching the display device 5 is highly interested.

Then, the display data setting unit 4006 registers, in the display data information unit 4033, the terminal ID acquired by the acquisition unit 4001 and the selected display data in association with each other. Next, the display data setting unit 4006 extracts, from the position information unit 4032, the terminal ID corresponding to the display device 5 identified by the identification unit 4005. In other words, the display data setting unit 4006 extracts the customer C near the display device 5 identified by the identification unit 4005.

Further, the display data setting unit 4006 reads the display data corresponding to the extracted terminal ID from the display data information unit 4033, and sets the largest number of pieces of display data as the display data to be output to the display device 5. In other words, the display data setting unit 4006 sets, as the display data to be output to the display device 5, the display data to emphasize a feature the largest number of customers C near the display device 5 (as identified by the identification unit 4005) are considered to be interested.

The output unit 4004 outputs the display data set by the display data setting unit 4006 to the display device 5 identified by the identification unit 4005.

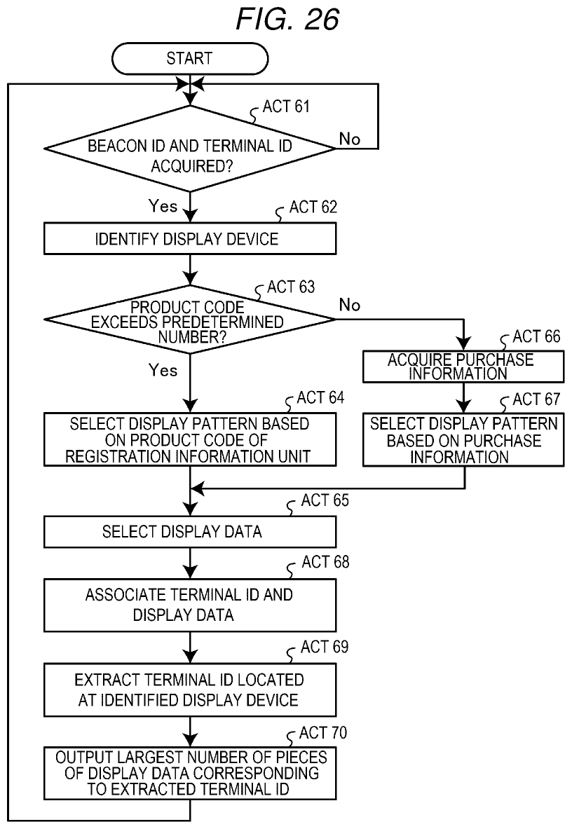

Display data output of the server device 4 based on the above configuration will be described. FIG. 26 is a flowchart illustrating a flow of the display data output of the server device 4.

The control unit 40 determines whether the acquisition unit 4001 acquires, from the terminal device 6, the beacon ID and the terminal ID associated with each other (ACT 61), and if the acquisition unit 4001 does not acquire the beacon ID and the terminal ID (No in ACT 61), the control unit 40 returns to ACT 61 and waits. If the acquisition unit 4001 acquires the beacon ID and the terminal ID (Yes in ACT 61), the identification unit 4005 identifies, based on the acquired beacon ID, the display device 5 at which the terminal device 6 identified according to the terminal ID is located (ACT 62).

The selection unit 4003 refers to the registration information unit 4031 and determines whether the number of the product codes corresponding to the terminal ID acquired by the acquisition unit 4001 exceeds a predetermined number (ACT 63). When the number of the product codes corresponding to the terminal ID acquired by the acquisition unit 4001 exceeds the predetermined number (Yes in ACT 63), the selection unit 4003 selects the display pattern based on the product code registered in the registration information unit 4031 corresponding to the terminal ID (ACT 64).

The display data setting unit 4006 selects the display data based on the selected display pattern and the display device 5 identified by the identification unit 4005 (ACT 65). In ACT 63, if the number of the product codes corresponding to the terminal ID acquired by the acquisition unit 4001 is equal to or less than the predetermined number (No in ACT 63), the purchase information acquisition unit 4002 acquires the purchase information (ACT 66). Next, the selection unit 4003 selects the display pattern based on the purchase information acquired by the purchase information acquisition unit 4002 (ACT 67).

After the selection of the display data, the display data setting unit 4006 registers, in the display data information unit 4033, the selected display data and the terminal ID acquired by the acquisition unit 4001 in association with each other (ACT 68). The display data setting unit 4006 extracts, from the position information unit 4032, the terminal ID corresponding to the display device 5 identified by the identification unit 4005 (ACT 69). The display data setting unit 4006 reads the display data corresponding to the extracted terminal ID from the display data information unit 4033, and outputs the largest number of pieces of display data to the terminal device 6 identified according to the terminal ID acquired by the acquisition unit 4001 (ACT 70). Then, the control unit 40 returns to ACT 61.

The server device 4 according to the third embodiment has the following configuration.

The server device 4 is capable of communicating with the display device 5 that is provided corresponding to each displayed product and that displays information on the corresponding product. The server device 4 includes: a position information acquisition unit (the acquisition unit 4001) that acquires the position information indicating the position of the terminal device 6 moving together with a customer; the identification unit 4005 that identifies, based on the position information acquired by the position information acquisition unit (the acquisition unit 4001), the display device 5 at which the terminal device 6 is located; the acquisition unit 4001 that acquires, from the terminal device 6, the terminal identification information (the terminal ID) for identifying the terminal device 6 and the product identification information (the product code) for identifying the product to be purchased by the customer C; the selection unit 4003 that selects any one of the plurality of pieces of predetermined display data based on the product identification information acquired by the acquisition unit 4001; and the output unit 4004 that outputs the display data selected by the selection unit 4003 to the display device 5 identified by the identification unit 4005.

Accordingly, the display system 3 including the server device 4 according to the third embodiment attains the same effects as those according to the first embodiment and the second embodiment. In addition, according to the third embodiment, since the display device 5 only needs to receive the display data from the server device 4 and then display the display data, processing load of the display device 5 can be reduced.

As in the first embodiment, the server device 4 may select the display pattern based on the product identification information acquired from the terminal device 6 and output the pattern ID to the display device 5. In this case, the display device 5 stores the setting data and the display pattern in which the display item is defined, and displays the setting data in the display pattern indicated by the received pattern ID to display the product information.

In the above embodiments, the control programs executed by the server device 4, the display device 5, and the terminal device 6 may be recorded in a non-transitory computer-readable recording medium such as a CD-ROM. In addition, the control programs executed by the devices according to the above embodiments may be stored in a computer connected to a network such as the Internet and may be downloaded via the network, or may be provided or accessed via the network such as the Internet.

While certain embodiments have been described, these embodiments have been presented by way of example only, and are not intended to limit the scope of the disclosure. For example, in the example embodiments, the display items (the product name, the price, the production district, the new product information, and the special information) are the same in all display patterns. In other examples, the display items may be different display items according to the display pattern.

In an embodiment, if the number of the purchased products of the customer C is equal to or less than the predetermined number, the server device 4 selects the display pattern or the display data based on the past purchase information of the customer C. However, the display pattern or the display data can also be selected based on the past purchase information of the customer C regardless of the number of the purchased products of the customer C. Further, the display pattern or the display data can be selected based on the purchased products regardless of the number of the purchased products of the customer C. In this case, the server device 4 selects the standard pattern or the display data for the standard pattern if there is no purchased product yet.

The embodiments can be implemented in other various forms, and various omissions, replacements, and changes can be made without departing from the spirit of the disclosure. The embodiments and the modifications thereof are included in the scope and spirit of the disclosure and are also included in the disclosure described in the claims and an equivalent scope thereof.

What is claimed is:

1. A display system for retail stores, the system comprising:
a display device at a location proximate to a displayed product and configured to display information regarding the displayed product on a display screen; and
a server device to communicate with the display device, the server device including a processor configured to:
acquire, from a mobile terminal device of a customer, a terminal identification for the mobile terminal device and product identification information regarding products registered for purchase by the customer using the mobile terminal device,
select a display pattern type from a plurality of display pattern types based on the acquired product identification information, and
output a pattern identification identifying the selected display pattern type to the mobile terminal device, wherein
the display device includes:
a detection unit configured to detect the pattern identification being output by the mobile terminal device when the mobile terminal device is within a predetermined range of the display device, and
a display control unit configured to display the information regarding the displayed product on the display screen in a display pattern corresponding to the display pattern type indicated by the pattern identification detected by the detection unit.

2. The display system according to claim 1, wherein
the processor is further configured to:
acquire, from the mobile terminal device, a customer identification identifying the customer, and
acquire past purchase information for the identified customer; and
the display pattern type is selected based on the acquired product identification information and the acquired past purchase information.

3. The display system according to claim 1, wherein
the mobile terminal device also outputs the terminal identification, and
the detection unit also detects the terminal identification associated with the pattern identification being output by the mobile terminal device.

4. The display system according to claim 3, wherein the display control unit is configured to display the information regarding the displayed product in the display pattern corresponding to the display pattern type indicated by the pattern identification detected for the largest number of mobile terminal devices within the predetermined range if the detection unit detects terminal identifications from a plurality of mobile terminal devices within the predetermined range.

5. The display system according to claim 1, wherein the display screen is a liquid crystal display.

6. The display system according to claim 1, wherein the mobile terminal device broadcasts the pattern identification via a short-range wireless communication protocol.

7. The display system according to claim 1, wherein the mobile terminal is mounted on a shopping cart.

8. The display system according to claim 1, wherein the mobile terminal is a smartphone carried by the customer.

9. The display system according to claim 1, wherein the display device is mounted on a display shelf.

10. The display system according to claim 9, wherein
a plurality of products are displayed on the display shelf, and
a plurality of display devices are respectively mounted on the display shelf in correspondence with each of the plurality of products displayed on the display shelf.

11. The display system according to claim 1, wherein
the product identification information includes feature information regarding the products registered for purchase by the customer, and
the display pattern type is selected to emphasize a feature of the displayed product corresponding to the feature information of at least one product in the product identification information.

12. A display system for retail stores, the system comprising:
a display device at a location proximate to a displayed product and configured to display information regarding the displayed product on a display screen; and
a server device to communicate with the display device, the server device including a processor configured to:
acquire, from a mobile terminal device of a customer, a terminal identification for the mobile terminal device and product identification information regarding products registered for purchase by the customer using the mobile terminal device,
select a display pattern type from a plurality of display pattern types based on the acquired product identification information, and
output, to the display device, a pattern identification for identifying the selected display pattern type along with the acquired terminal identification in association with each other, wherein
the display device includes:
a detection unit configured to detect if the mobile terminal device corresponding to the terminal identification is within a predetermined range, and
a display control unit configured to display information regarding the displayed product on the display screen in a display pattern corresponding to the display pattern type indicated by pattern identification associated with the terminal identification of the mobile terminal device detected by the detection unit.

13. The display system according to claim 12, wherein
the processor is further configured to:
acquire, from the terminal device, a customer identification identifying the customer, and
acquire past purchase information for the identified customer; and
the display pattern type is selected based on the acquired product identification information and the acquired past purchase information.

14. The display system according to claim 12, wherein
the product identification information includes feature information regarding the products registered for purchase by the customer, and
the display pattern type is selected to emphasize a feature of the displayed product corresponding to the feature information of at least one product in the product identification information.

15. The display system according to claim 12, wherein the display control unit is configured to display the information regarding the displayed product in the display pattern corresponding to the display pattern type indicated by the pattern identification detected for the largest number of mobile terminal devices within the predetermined range if the detection unit detects a plurality of terminal identifications within the predetermined range.

16. A server device for a display system, the server device comprising:
a network communication interface to communicate with a display device that is at a location proximate to a displayed product and configured to display information regarding the displayed product on a display screen; and
a processor configured to:
acquire, from a mobile terminal device of a customer, a terminal identification for the mobile terminal device and product identification information regarding products registered for purchase by the customer using the mobile terminal device,
select a display pattern type from a plurality of display pattern types based on the acquired product identification information, and
output a pattern identification identifying the selected display pattern type to at least one of the mobile terminal device or the display device.

17. A display device to be located proximate to a displayed product, the display device comprising:
a display screen to display information for a displayed product located proximate to the display screen;
a detection unit configured to detect a pattern identification being output by a mobile terminal device when the mobile terminal device is within a predetermined range of the display device; and
a display control unit configured to display information regarding the displayed product on the display screen in a display pattern corresponding to the display pattern type indicated by the pattern identification detected by the detection unit.

18. The display device according to claim 17, further comprising:
a storage unit storing a plurality of display patterns in association with pattern identifications; and
an extraction unit configured to extract, from the storage unit, the display pattern associated with the pattern identification detected by the detection unit.

19. The display device according to claim 17, wherein the detection unit includes a short-range wireless communication unit.

20. The display device according to claim 17, wherein the short-range wireless communication unit is configured to communicate using a Bluetooth communication protocol.
